(19) United States
(12) Patent Application Publication
(10) Pub. No.: US 2011/0021954 A1
(43) Pub. Date: Jan. 27, 2011

(54) EXERCISE SYSTEM

(75) Inventors: Toshio Nakano, Osaka-shi (JP); Bungo Imai, Hirakata-shi (JP); Wataru Sanematsu, Hirakata-shi (JP); Youichi Shinomiya, Ibaraki-shi (JP); Fumihiro Nishio, Hikone-shi (JP)

Correspondence Address: EDWARDS ANGELL PALMER & DODGE LLP, P.O. BOX 55874, BOSTON, MA, 02205, US

(73) Assignee: Panasonic Electric Works Co., Ltd., Kadoma-shi (JP)

(21) Appl. No.: 12/736,306

(22) PCT Filed: Mar. 31, 2008
(86) PCT No.: PCT/JP2008/056430

§ 371 Date: Sep. 28, 2010

(51) Int. Cl. A61H 1/00

(52) U.S. Cl. 601/5

(57) ABSTRACT

A program selecting means 22 which selects an exercise program appropriate for a user on the basis of user information obtained by the user information obtaining means 21, a device control means 25 which causes a passive exercise device 1 to perform an operation on the basis of the selected exercise program, and a program varying means 23 which varies the selected exercise program in a prescribed range in accordance with an instruction of the user are comprised. A user can vary the exercise program being selected on the basis of the user information, in accordance with user's preference. Because this variation is permitted only within a prescribed range, such a variation that is to provide the user with excessive stress can be prevented.

### TECHNICAL FIELD

The invention relates generally to an exercise system and, more particularly, to an exercise system that provides a user with an effect of exercise by giving a passive fluctuation stimulation.

### BACKGROUND ART

In the past, there has been such an exercise device that causes a to user exercise by giving a passive fluctuation stimulation. To the exercise device of its kind, an exercise system that mimics a horse riding, as disclosed in patent document 1, is known.

With regard to a passive type exercise system that can change exercise intensity and/or can change muscles to be trained by changing the motion speed, the motion range and so on, such an exercise system, with which a user can easily perform an exercise with appropriate intensity and/or pattern for the physical strength or previous illness of the user, is also provided. For example, there has been such an exercise system that selects an exercise program based on such as age, physical strength, and exercise experience of a user by the exercise system side, the exercise program being to provide the user with exercise with appropriate intensity and/or pattern. The exercise system provides the user with exercise on the basis of the selected exercise program (see the patent document 2).

The patent document 1: Japanese Patent Application Laid-Open No. 2001-286578
The patent document 2: Japanese Patent Application Laid-Open No. 2007-29704

### DISCLOSURE OF THE INVENTION

### Problems to be Solved by the Invention

The exercise program, which is selected and arranged for a user by the exercise system side, may be selected with consideration for such as age, body size, physical strength and previous illness of the user. However, not all the users are satisfied with the exercise program selected for each user, because the body size, the physical strength, the exercise experience, and the previous illness etc. of each user are of great variety.

However, it may be a great strain for a user to produce and conduct an exercise program reflecting user's preference etc. Furthermore, because the user is not always aware the user's physical strength etc. correctly, the user may select an excessive exercise in some cases.

The user is not satisfied with the exercise performed by the exercise system, which significantly degenerate the continuity about that the user performs exercise using the exercise system.

In the light of the above, and it is an object of the present invention to provide an exercise system that gives a satisfying exercise to a user with convenient and safe manner.

### Means for Solving the Problem

In order to achieve the above object, an exercise system of the present invention comprises: a user information obtaining means which obtains user information; a program selecting means which selects an exercise program appropriate for a user on the basis of the user information obtained by the user information obtaining means; and a device control means which causes a passive exercise device to perform an operation on the basis of the exercise program selected by the program selecting means, wherein the passive exercise system comprises a program varying means which varies the exercise program selected by the program selecting means within a prescribed range in accordance with an instruction of the user, wherein the device control means drives the passive exercise device on the basis of the exercise program varied by the program varying means.

The exercise system is so configured that a user can vary the exercise program, which is selected by the program selecting means based on the user information, according to user's preference, and configured to permit this variation only within a prescribed range. It becomes then possible to prevent an excessive stress from being applied to the user.

In this case, it is preferred that the prescribed range within which the exercise program by the program varying means can be varied is different between an initial stage and a late stage of the exercise program.

It is also preferred that the prescribed range within which the exercise program by the program varying means can be varied is different according to the user information. It is also preferred that there is provided a modification means for modifying the prescribed range within which the exercise program by the program varying means can be varied.

Preferably, the program selecting means selects the exercise program by further referring usage history information of the passive exercise system included in the user information.

Preferably, the program selecting means comprises a presenting means for presenting one or more selected exercise programs to the user, said program selecting means being configured to settle the exercise program according to an input by the user with respect to the presented exercise program.

Furthermore, the program selecting means may be configured to select the exercise program on the basis of a predetermined rule which defines an execution sequence of a plurality of exercise programs.

Preferably, there is provided an exercise program updating means for updating the exercise program selected on the basis of the user information.

There may be provided an exercise amount calculation means for calculating an exercise amount about a user's exercise provided by the operation of the passive exercise device based on the varied exercise program.

There may be provided an evaluation means for evaluating a user's exercise condition performed by the operation of the passive exercise device based on the varied exercise program. In this case, the program selecting means may be configured to refer an evaluation result obtained by the evaluation means when the exercise program is selected. Also, there may be provided a storage means for storing an evaluation result obtained by the evaluate means as a part of usage history information of the passive exercise system.

Preferably, there is provided a judging means for judging whether or not an exercise of the user performed by the operation of the passive exercise device based on the exercise program reaches a predetermined goal, and for presenting a judged result to the user.

### Advantageous Effect of the Invention

The exercise system in accordance with the invention of claim 1 is configured that a user can vary an exercise program according to the user's preference when the user exercises on the basis of the exercise program selected based on user information. Furthermore, this variation is permitted only within a prescribed range. As a result, although the variation is allowed, such a variation that may be to apply an excessive stress to the user can be prevented. Therefore, not only a flexibility of the variation so as to reflect the preference of the user can be obtained, but also safety can be ensured.

In the invention of claim 2, a reasonable variation for the user of the exercise program can be obtained reliably, by restricting a variation permission range of the exercise program in an initial stage of exercise based on the exercise program because a body is unused to exercise, and by expanding the variation permission range of the exercise program in a late stage.

In the invention of claim 3, because a variation permission range can be set according to the nature etc. of each user, safety can be further increased.

In the invention of claim 4, the variation can be done within more suitable range for a user by modifying a prescribed range within which a variation is permitted.

In the invention of claim 5, the exercise program is selected further based on an exercise history of a user. Therefore, it is advantageous in ensuring safety. In addition, such an exercise program that is more likely to increase the exercise effect can be selected.

In the invention of claim 6, because a user can perform exercise based on an exercise program reflecting the user's intention, user's motivation for exercise can be easily preserved.

In the invention of claim 7, exercise programs suitable for a user are selected in good order. Therefore, a good effect of exercise can be obtained in a short time.

In the invention of claim 8, because a new exercise program can be brought in, a user can perform exercise without being bored.

In the invention of claim 9, user is encouraged to exercise and continuity about exercise can be enhanced, with knowing the exercise amount.

In the invention of claim 10, whether or not to perform exercise appropriately can be known. Therefore, encouragement can be obtained, and continuity about exercise can be enhanced.

In the invention of claim 11, such an exercise program appropriate for a user's exercise adaptability is to be selected. Therefore, user's exercise capacity can be improved with respect to each user.

In the invention of claim 12, because previous evaluation results can be obtained, the effect about performing exercise can be known adequately.

In the invention of claim 13, user's motivation for exercise can be can produced by a presented evaluation result, and continuity for exercise can be enhanced.

### BRIEF DESCRIPTION OF THE DRAWINGS

FIG. 1 is a schematic block circuit diagram of an example in accordance with an embodiment of the present invention.

FIG. 2 is an illustration diagram of an example in accordance with a device control table of said embodiment.

FIG. 3 is an illustration diagram of an example in accordance with a modification rule table of said embodiment.

FIG. 4 is an illustration diagram of an example in accordance with a variation permission table of said embodiment.

FIG. 5 is an illustration diagram of an example in accordance with an exercise amount table of said embodiment.

FIG. 6 is an illustration diagram of an example in accordance with a personal data table of said embodiment.

FIG. 7 is an illustration diagram of an example in accordance with a history data table of said embodiment.

FIG. 8 is an illustration diagram of an example in accordance with a feedback rule table of said embodiment.

FIG. 9 is an elevation view of a display example in accordance with an information presenting part of said embodiment.

### EXPLANATION OF REFERENCES

1 PASSIVE EXERCISE DEVICE
2 CONTROL MEANS
3 INPUT PART
4 INFORMATION PRESENTING PART
5 DATABASE FOR PROGRAM
6 PERSONAL INFORMATION DATABASE
20 MEMORY
21 USER INFORMATION OBTAINING PART
22 PROGRAM SELECTING PART
23 PROGRAM VARYING PART
24 EXERCISE AMOUNT CALCULATION PART
25 DEVICE CONTROL PART

### BEST MODE FOR CARRYING OUT THE INVENTION

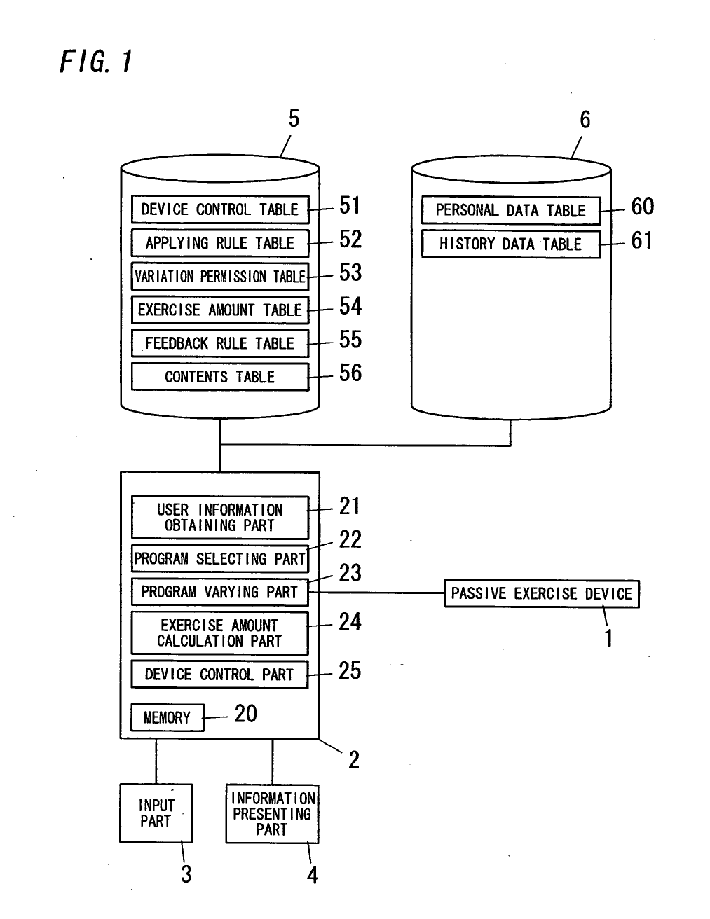

The present invention will now be explained based on the embodiment shown in attached drawings. FIG. 1 shows an exercise system according to the present invention. The exercise system is fundamentally constructed from a passive exercise device 1 and a control means 2 for controlling the operation of the passive exercise device 1.

The passive exercise device 1 includes an engine such as a motor etc. The passive exercise device is configured to provide a user with a passive fluctuation stimulation by moving, by means of this engine, a part of devices on which the user rides or contacts. The user is to exercise by body movements caused by the stimulation or body movements caused as a reaction to the stimulation.

In the present invention, the passive exercise device 1 is not limited by its kind or its function. Therefore, practical configuration of the passive exercise device 1 is omitted now. In regard to the explanation below, such a passive exercise device 1 that can change a motion speed, change a stress being provided to the user, change a tilt (inclining motion) against the direction of gravity acceleration, and perform an elevating motion, is assumed.

The control means 2 is fundamentally constructed from a microcomputer. The control means 2 comprises a memory 20 for storing a work of the microcomputer. The control means 2 also has a user information obtaining part 21, a program selecting part 22, a program varying part 23, an exercise amount calculation part 24 and a device control part 25, as a function of a software executed by the microcomputer. The device control part 25 manages the operation control of the activating device 1.

An input part 3 for an input by the user and an information presenting part (a display) 4 for presenting information to the user are connected to the control means 2. Furthermore, a database for program 5 and a user information database 6 are also connected to the control means 2.

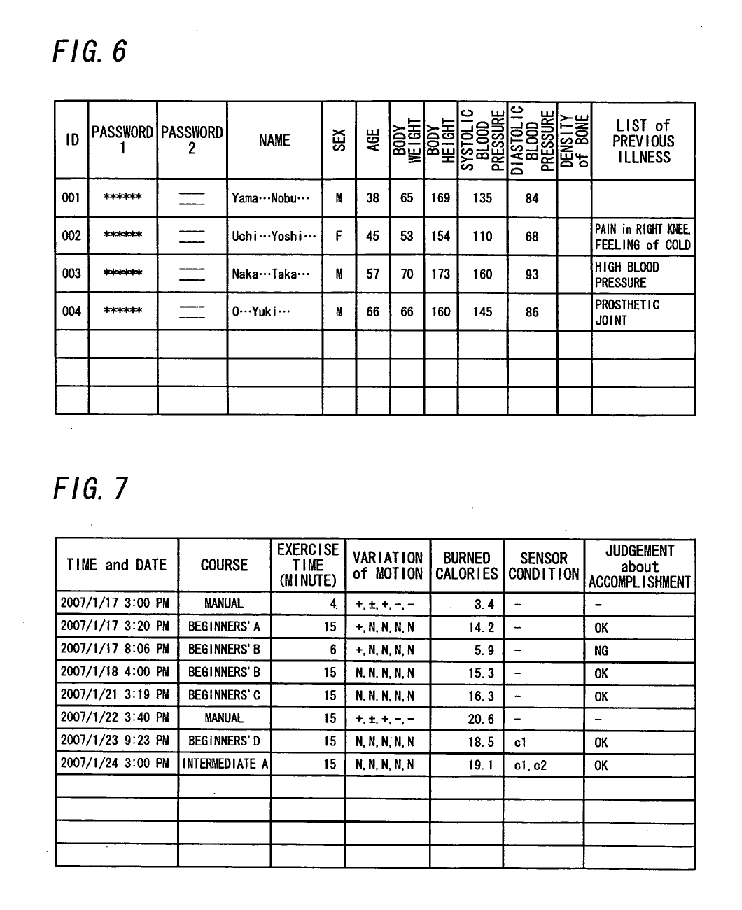

The user information database 6 contains, as shown in FIG. 6, a personal data table 60 in which a plurality of user's personal information are stored and a history data table 61. An example of description of the personal data table 60 is shown in FIG. 6. As shown in FIG. 6, name, sex, age, body weight, body height, systolic blood pressure, diastolic blood pressure, density of bone, list of previous illnesses etc. are stored with respect to each user with the ID.

The history data table 61 describes a usage history with respect to each user. The usage history contains that which exercise program (exercise course) is performed, when the exercise based on the exercise program is performed, and how many calories are burned at the exercise. An example of the history data table 61 is shown in FIG. 7. The item about variation of motion in FIG. 7 describes that whether a variation of the exercise program, which is mentioned below, is done in the direction for increasing the exercise amount (+), or in the direction for decreasing the exercise amount (−). N shows that the variation is not done.

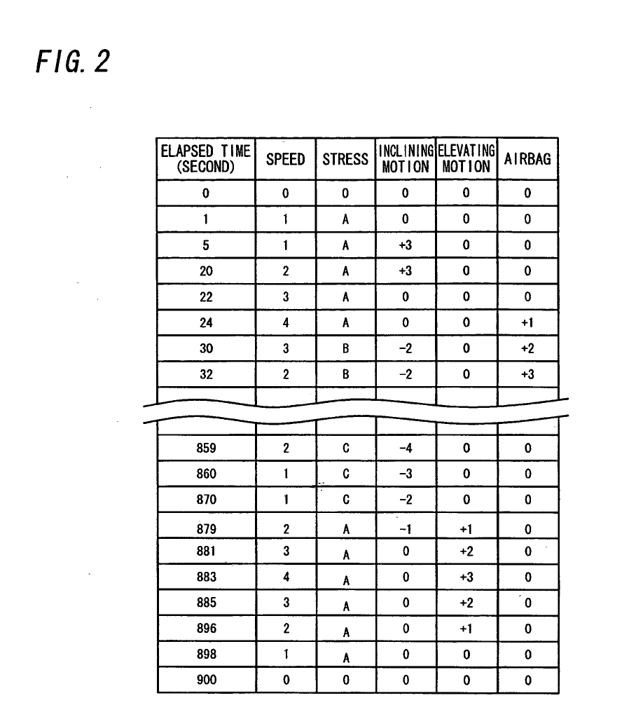

The database for program 5 contains a device control table 51, an applying rule table 52, a variation permission table 53, an exercise amount table 54, a feedback rule table 55 and a contents table 56. The device control table 51 substantially constructs the exercise program. The device control table 51 describes operation parameters about the speed, the stress, the inclining motion, and the elevating motion according to an elapsed time of exercise with respect to each exercise adaptability of the user. An example of the exercise program (for beginners' C) aimed at a user having particular exercise adaptability is shown in FIG. 2. Each exercise program is assigned a program ID, respectively.

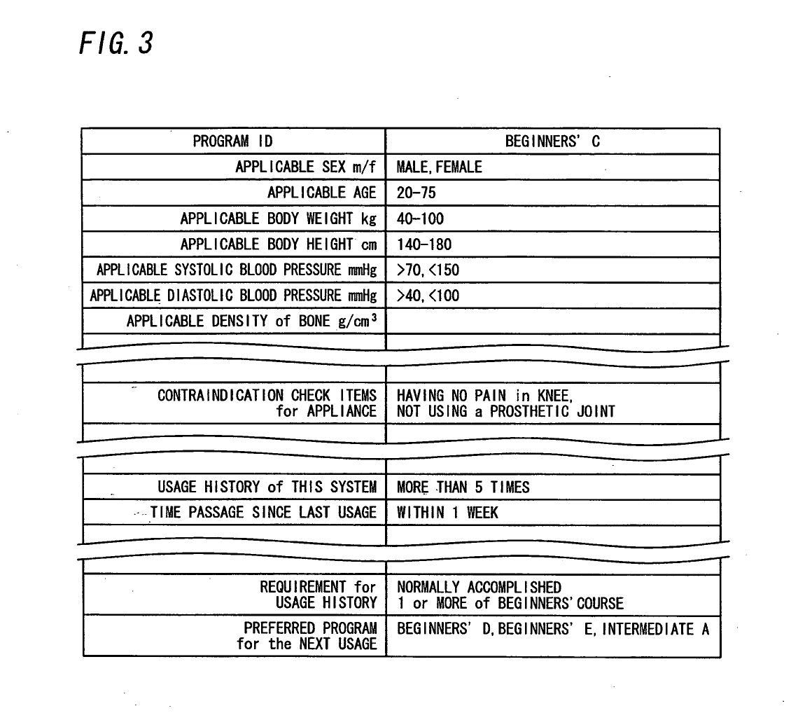

The applying rule table 52 describes that which users are aimed by each of exercise programs. In FIG. 3, a description example about the applying rule table 52 whose program ID is defined as “beginners' C” is shown. The applying rule table 52 has descriptions such as an applicable sex, an applicable age, an applicable body weight, an applicable body height, an applicable systolic blood pressure, an applicable diastolic blood pressure, an applicable density of bone, a contraindication check items for appliance, a usage history of this system, time passage since last usage, a requirements for usage history, and a preferred program for the next usage.

When a user input the user's ID number via the input part 3, the user information obtaining part 21 in the control means 2 accesses the personal data table 60 and the history data table 61 of the user information table 6, and reads out personal information and the history information corresponding to the user's ID.

If the control means 2 is set on such a mode to perform an automatic selection of the program, the program selecting part 22 selects an applying exercise program from the applying rule table 52 on the basis of the user information and the history information obtained by the user information obtaining part 21. Whereupon, the control means 2 reads out data of the device control table 51 by its program ID to read out the exercise program corresponding to this program ID, and to set the exercise program on the memory 20. In addition, the control means 2 reads out the information (content) about its exercise program from the contents table 56 to display on the information presenting part 4.

If there is more than one exercise programs appropriate for the user information, it is preferred to select an exercise program that needs less exercise adaptability or to display the list of those exercise programs on the information presenting part 4 so that a user can select. FIG. 9 shows an example of the display of the information presenting part 4 in this case.

When the exercise program is selected to be set on the memory 20 as described above, the control means 2 performs a motion control of the passive exercise device 1, via the device control part 25, based on the operation parameters of the exercise program set on the memory 20 according to the passage of time, and enables the operation of the program varying part 23.

The program varying part 23 varies the operation parameters, related to the presently performed exercise, of the exercise program developed on the memory 20, depending on the user's input from the input part 3. The device control part 25 changes the motion of the passive exercise device 1 immediately in response to the variation of the operation parameters. In varying the operation parameters, unrestrained variation is not permitted here. The variation is permitted only in a range described on the variation permission table 53.

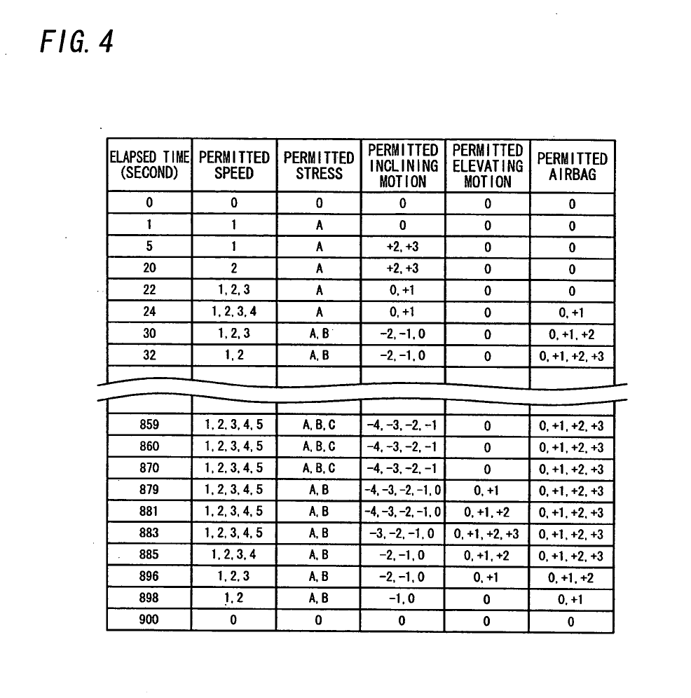

The variation permission table 53 describes permission ranges about the speed, the stress, the inclining motion, and the elevating motion with respect to each exercise programs according to the passage of time. An example of the variation permission table 53 corresponding to the exercise program shown in FIG. 2 is shown in FIG. 4. As is clear from the figure, in an early stage of the exercise program, the variation is not permitted in the direction for increasing exercise stress. While, in a latter stage of the exercise program, the variation is also permitted in the direction for increasing exercise stress. Furthermore, the permission ranges of the variation are small in shortly after the start of the exercise and shortly before the end of the exercise.

The user can vary the content of the exercise program selected by the program selecting means 22, and to customize the exercise program so as to suit the user's preference. However, the variation can be done only in the permitted ranges. Therefore, even if the user tries to widely changes the content of the exercise program being selected as appropriate for the user, improper exercise can be prevented to being given to the user.

In addition, a plurality of permission variation tables 53 having different permission ranges with each other may be arranged with respect to an exercise program of a particular program ID, and an applied permission variation table 53 may be selected according to the user information or an instruction of the user. In this case, when being used by a child or an aged person, a range within which the variation is permitted can be further restricted. Therefore, safety can be improved.

It is preferred that the description of a variation permission table 53 itself, that is a prescribed range, can be modified. For example, if a user feels the exercise stress excessive while a particular exercise program is performed and exercise stress is provided in a range within which exercise program is permitted to vary, the user changes the corresponding permission ranges on the variation permission table 53 so that the exercise stress becomes small. Thereby, from the next usage, such an exercise that is to provide the user with excessive exercise stress can be prevented when the exercise stress is increased within the permitted range. Therefore, the user can vary without worrying about causing such a matter that the exercise stress becomes excessive.

Above-described permission variation table 53 is configured to describe operation parameters which are permitted to vary, however it may be configured to describe operation parameters which are not permitted to vary.

In the above, the variation of the exercise program with respect to an instruction of a user has been explained. However, if sensors S, which can detect that how the user's exercise is performed, are arranged at the passive exercise device 1 side, the exercise system can be configured to vary the exercise program automatically with reference to the outputs from these sensors within the range permitted by the variation permission table 53.

For example, above sensors can be replaced with a sensor that can measure a stability level of the body of the user, and a sensor that can measure a stepping power of the user. In this case, these sensors rate the stability level of the body on three-point scale of a, b, c and output the evaluation result, and rate the stepping power on five-point scale of 1˜5 and output the evaluation result. If the exercise adaptability of the user is judged high on ground of the evaluation results, the operation parameters are varied in the direction for increasing exercise stress. While, if the exercise adaptability of the user is judged low on ground of the evaluation results, the operation parameters are varied in the direction for decreasing exercise stress.

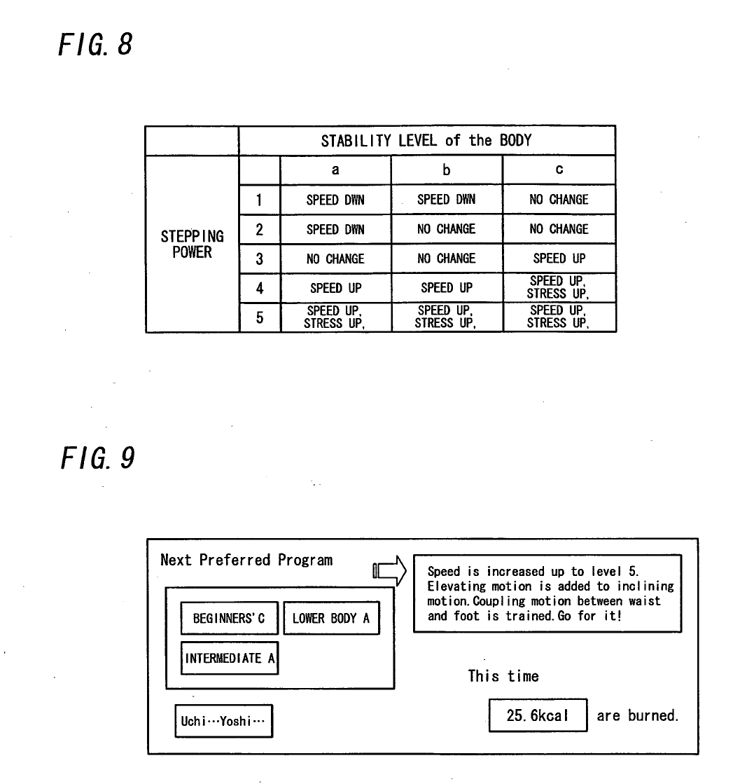

Such operation can be achieved by configuring as that the program varying part 23 varies the operation parameters about the speed and the stress with reference to the feedback rule table 55 (as shown in FIG. 8). For example, if the evaluation output about the stepping power is 1 and the stability level of the body is a, the rule of decreasing speed (SPEED DWN) is applied to decrease the speed one-step. While, if the evaluation output about the stepping power is 15 and the stability level of the body is c, the rule of SPEED UP and STRESS UP is applied to increase the speed and the stress.

This variation may go beyond the range permitted by the variation permission table 53. Because this variation is performed based on the evaluation of the exercise adaptability of the user, an excessive exercise is seldom provided to the user by this variation. Furthermore, this variation may be combined with the above-described variation according to an instruction of a user.

By the way, an exercise amount is calculated to inform a user through the information presenting means 4 when the user performs an exercise in accordance with an exercise program. It becomes then possible that the user can grasp the exercise amount about the current exercise, and it is useful for a self-management of the user. Exercise amount at an exercise of a particular exercise program is indeterminate, because the exercise program is not fixed and is varied according to an instruction of a user (or according to an exercise capacity judged by the sensors S).

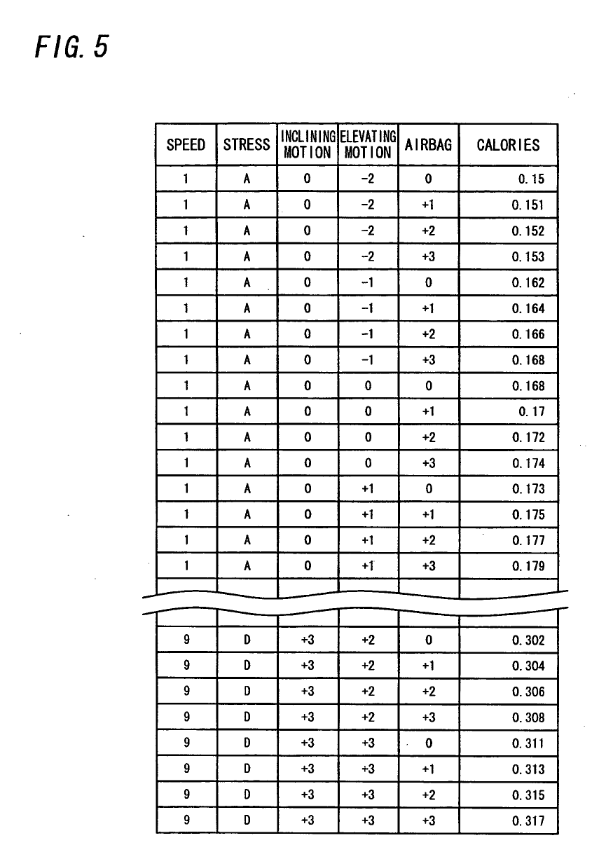

For this reason, the exercise amount calculation part 24 of the control means 2 is configured to calculate the exercise amount on the basis of data described on the exercise amount table 54, wherein the above mentioned variation is also taken into account in the data. An example of the exercise amount table 54 is shown in FIG. 5. It contains such data how many calories are burned with respect to each value of the operation parameters about the speed, the stress, the inclining motion and the elevating motion. The exercise amount calculation part 24 calculates the exercise amount based on the operation parameters, developed on the memory 20 and varied by the program variation means 23, and the exercise amount table 54. The exercise amount calculation part 24 integrates each exercise amount each time when the operation of the motion shifts to the next operation. When the selected exercise program finishes, the exercise amount calculation part 24 obtains total exercise amount (burned calories) about the exercise. This exercise amount is displayed on the information presenting part 4 when the exercise finishes.

In the meanwhile, when the exercise performed by the selected exercise program finishes, the control means 2 stores the information in the corresponding space to the user in the above-described history data table 61. This information can be referred as history data in selecting an exercise program at next exercise. Preferably, this history data table 61 stores not only the performed exercise program, but also the exercise time, information about the variation of the operation, amount of burned calories, the judged result of the sensors S, and information whether the exercise has completed or not (whether the exercise has reached the goal or not), as shown in FIG. 7.

There may be a large number of applicable exercise programs if exercise programs are selected based only on user's personal information. It becomes easy to select an appropriate exercise program by referring the history information on which exercise programs performed by the user in past times and the exercise results (which contain the evaluation result about exercise adaptability) etc. are described. It is effective that requirement for usage history and/or preferred programs for the next usage are described on the applying rule table 52, as described above. In this case, the selection is performed based on a rule which defines an execution sequence of a plurality of exercise programs.

Furthermore, user's motivation for exercise can be enhanced, if the exercise system reads out the information whether or not the exercise on the basis of the exercise program has accomplished at last exercise from the history information, and to display it on the information presenting part 4.

Preferably, each table contained in the database for program 5 can be updated from outside. New exercise programs can be introduced occasionally.

1. A passive exercise system comprising:
a user information obtaining means which obtains user information;
a program selecting means which selects an exercise program appropriate for a user on the basis of the user information obtained by the user information obtaining means; and
a device control means which causes a passive exercise device to perform an operation on the basis of the exercise program selected by the program selecting means,
wherein the passive exercise system comprises a program varying means which varies the exercise program selected by the program selecting means within a prescribed range in accordance with an instruction of the user,
wherein the device control means drives the passive exercise device on the basis of the exercise program varied by the program varying means.

2. The passive exercise system as set forth in claim 1, wherein the prescribed range within which the exercise program by the program varying means can be varied is different between an initial stage and a late stage of the exercise program.

3. The passive exercise system as set forth in claim 1, wherein the prescribed range within which the exercise program by the program varying means can be varied is different according to the user information.

4. The passive exercise system as set forth in claim 1, comprising a modification means for modifying the prescribed range within which the exercise program by the program varying means can be varied.

5. The passive exercise system as set forth in claim 1, wherein the program selecting means selects the exercise program by further referring usage history information of the passive exercise system included in the user information.

6. The passive exercise system as set forth in claim 1, wherein the program selecting means comprises a presenting means for presenting one or more selected exercise programs to the user, said program selecting means being configured to settle the exercise program according to an input by the user with respect to the presented exercise program.

7. The passive exercise system as set forth in claim 1, wherein the program selecting means selects the exercise program on the basis of a predetermined rule which defines an execution sequence of a plurality of exercise programs.

8. The passive exercise system as set forth in claim 1, comprising an exercise program updating means for updating the exercise program selected by the program selecting means on the basis of the user information.

9. The passive exercise system as set forth in claim 1, comprising an exercise amount calculation means for calculating an exercise amount about a user's exercise provided by the operation of the passive exercise device based on the varied exercise program.

10. The passive exercise system as set forth in claim 1, comprising an evaluation means for evaluating a user's exercise condition performed by the operation of the passive exercise device based on the varied exercise program.

11. The passive exercise system as set forth in claim 10, wherein the program selecting means refers an evaluation result obtained by the evaluation means when the exercise program is selected.

12. The passive exercise system as set forth in claim 10, comprising a storage means for storing an evaluation result obtained by the evaluating means as a part of usage history information of the passive exercise system.

13. The passive exercise system as set forth in claim 1, comprising a judging means for judging whether or not an exercise of the user performed by the operation of the passive exercise device based on the exercise program reaches a predetermined goal, and for presenting a judged result to the user.

14. The passive exercise system as set forth in claim 2, wherein the prescribed range within which the exercise program by the program varying means can be varied is different according to the user information.

15. The passive exercise system as set forth in claim 2, comprising a modification means for modifying the prescribed range within which the exercise program by the program varying means can be varied.

16. The passive exercise system as set forth in claim 2, wherein the program selecting means selects the exercise program by further referring usage history information of the passive exercise system included in the user information.

17. The passive exercise system as set forth in claim 2, wherein the program selecting means comprises a presenting means for presenting one or more selected exercise programs to the user, said program selecting means being configured to settle the exercise program according to an input by the user with respect to the presented exercise program.

18. The passive exercise system as set forth in claim 2, wherein the program selecting means selects the exercise program on the basis of a predetermined rule which defines an execution sequence of a plurality of exercise programs.

19. The passive exercise system as set forth in claim 2, comprising an exercise program updating means for updating the exercise program selected by the program selecting means on the basis of the user information.

20. The passive exercise system as set forth in claim 2, comprising an exercise amount calculation means for calculating an exercise amount about a user's exercise provided by the operation of the passive exercise device based on the varied exercise program.
